(19) United States
(12) Patent Application Publication
(10) Pub. No.: US 2026/0239318 A1
(43) Pub. Date: Aug. 13, 2026

(54) USER EQUIPMENT AND METHODS OF RESOURCE ALLOCATION ENHANCEMENT FOR SBFD OPERATION

(71) Applicant: SHENZHEN TCL NEW TECHNOLOGY CO., LTD., Shenzhen, Guangdong (CN)

(72) Inventor: Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 19/151,277

(22) PCT Filed: Apr. 7, 2023
(86) PCT No.: PCT/CN2023/087026

§ 371 Date: Jul. 25, 2025

(51) Int. Cl. H04W 72/0453; H04L 5/14; H04W 52/08; H04W 72/232

(52) U.S. Cl. CPC H04W 72/0453; H04L 5/14; H04W 52/08; H04W 72/232

(57) ABSTRACT

Various methods relate to methods of enhanced frequency resource allocation for sub-band full duplex (SBFD) operation, methods of separate parameters indication in SBFD and non-SBFD symbols, and devices such as a user equipment (UE) and a base station. The method of enhanced frequency resource allocation for SBFD operation includes determining, by a node, a physical downlink shared channel (PDSCH) transmission/reception in a downlink (DL) subband and/or a physical uplink shared channel (PUSCH) transmission/reception in an uplink (UL) subband based on an enhanced frequency resource allocation for SBFD operation, wherein the enhanced frequency resource allocation for SBFD operation includes a frequency resource allocation type 0 enhancement and a frequency resource allocation type 1 enhancement.

### BACKGROUND OF DISCLOSURE

### 1. Field of the Disclosure

The present disclosure relates to the field of wireless communication systems, and more particularly, to a user equipment (UE) and methods of resource allocation enhancement for sub-band full duplex (SBFD) operation in 5G new radio (NR) communication system. More specifically, the present disclosure discusses the enhancement of NR physical resource allocations for SBFD operation, such as the frequency domain resource allocation, and the implementation of SBFD operation and non SBFD operation in a single time slot and across multiple time slots.

### 2. Description of the Related Art

The diversified use cases and exponential growth of number of UEs in the next generation wireless communication system have increased the data traffic explosively which leads to the high requirements of spectral efficiency. In order to accomplish the requirements of high spectral efficiency, TDD system is widely adopted in commercial NR deployments. TDD system uses a single spectrum (frequency band) for downlink (DL) and uplink (UL) in different timeslots, and utilizes the available spectrum more efficiently as compared to the Frequency Division Duplex (FDD) system.

In conventional TDD system, the time domain resources are split between the downlink (DL), uplink (UL) and flexible slots/symbols, where the flexible slots/symbols can be used as DL, UL or as a guard period for DL-UL switching. Allocation of a limited time duration for uplink in conventional TDD would result in reduced coverage, increased latency and reduced capacity. In order to enhance the limitations of conventional TDD operation, 3GPP RAN working group approves a study item [1] in Rel-18, which focus on the feasibility of simultaneous existence of DL and UL, as known as, full duplex, or more specifically, sub-band non-overlapping full duplex operation within a conventional TDD band. In SBFD operation, gNB is operated in full duplex, i.e. the simultaneous DL and UL transmission occurs at gNB side only while the UE operates in half duplex. The study item specifies RAN1 objectives regarding the sub-band non-overlapping full duplex and dynamic/flexible TDD operation.

In prior art, several companies point out the limitation of the existing physical resource allocation for SBFD operation and propose to study further the enhancement of physical resources allocation for DL transmission and UL reception in time domain and frequency domain. However, there is no clear solution, which focus on what enhancements are required for physical resource allocation, and how to acquire the physical resources allocation enhancement (i.e., the methods) to make the physical resources suitable for SBFD operation. Therefore, there is a need to further study several enhancements to the physical resources and the methods of enhancement to the physical resource allocation especially in frequency domain.

### SUMMARY

An object of the present disclosure is to propose a user equipment (UE), a base station, methods of enhanced frequency resource allocation for sub-hand full duplex (SBFD) operation, and methods of separate parameters indication in SBFD and non-SBFD symbols, which have the following advantages. 1. The proposed methods and solutions consider the physical resource enhancement in frequency domain and utilize the frequency resources more efficiently. 2. The proposed methods and solutions consider the SBFD and non-SBFD operation in a slot, which increases the SBFD operation flexibility. 3. The proposed methods and solutions consider several parameters enhancement, which avoids the incorrect configuration of SBFD operation.

In a first aspect of the present disclosure, a method of enhanced frequency resource allocation for sub-band full duplex (SBFD) operation includes determining, by a node, a physical downlink shared channel (PDSCH) transmission/reception in a downlink (DL) subband and/or a physical uplink shared channel (PUSCH) transmission/reception in an uplink (UL) subband based on an enhanced frequency resource allocation for SBFD operation, wherein the enhanced frequency resource allocation for SBFD operation comprises a frequency resource allocation type 0 enhancement and a frequency resource allocation type 1 enhancement.

In a second aspect of the present disclosure, a method of enhanced frequency resource allocation for sub-band full duplex (SBFD) operation, includes determining a physical downlink shared channel (PDSCH) reception in DL subband and/or a physical uplink shared channel (PUSCH) transmission in UL subband, by a user equipment (UE), based on an enhanced frequency resource allocation, wherein the enhanced frequency resource allocation comprises a frequency resource allocation type 0enhancement and/or a frequency resource allocation type 1 enhancement.

In a third aspect of the present disclosure, a method of enhanced frequency resource allocation for sub-band full duplex (SBFD) operation, includes determining a PDSCH transmission in DL subband and a PUSCH reception in UL subband, by a base station (BS), based on an enhanced frequency resource allocation, wherein the enhanced frequency resource allocation comprises a frequency resource allocation type 0 enhancement and/or a frequency resource allocation type 1 enhancement.

In a fourth aspect of the present disclosure, a method of separate parameters indication in SBFD and non-SBFD symbols includes determining, by a node, a PDSCH transmission/reception and/or a PUSCH transmission/reception in SBFD and non-SBFD symbols in the same slots or across different slots with separate parameters in SBFD and non-SBFD symbols indicated by a base station (BS), wherein the separate parameters indication in the SBFD and non-SBFD symbols comprises a separate FDRA for PDSCH reception or PUSCH transmission/reception in the SBFD and non-SBFD symbols, a separate frequency hopping (FH) indication for PUSCH transmission/reception in the SBFD and non-SBFD symbols, and/or a separate closed loop UL power control for PUSCH transmission/reception in the SBFD and non-SBFD symbols.

In a fifth aspect of the present disclosure, a method of separate parameters indication in SBFD and non-SBFD symbols includes determining, by a UE, a PDSCH reception and/or a PUSCH transmission in SBFD and non-SBFD symbols in the same slots or across different slots with separate parameters in SBFD and non-SBFD symbols indicated by a base station (BS), wherein the separate parameters indication in the SBFD and non-SBFD symbols comprises a separate FDRA for PDSCH reception or PUSCH transmission in the SBFD and non-SBFD symbols, a separate frequency hopping (FH) indication for PUSCH transmission in the SBFD and non-SBFD symbols, and/or a separate closed loop UL power control for PUSCH transmission in the SBFD and non-SBFD symbols.

In a sixth aspect of the present disclosure, a method of separate parameters indication in SBFD and non-SBFD symbols includes determining, by a base station, a PDSCH transmission and/or a PUSCH reception in SBFD and non-SBFD symbols in the same slots or across different slots with separate parameters in SBFD and non-SBFD symbols, wherein the separate parameters indication in the SBFD and non-SBFD symbols comprises a separate FDRA for PDSCH transmission or PUSCH reception in the SBFD and non-SBFD symbols, a separate frequency hopping (FH) indication for PUSCH reception in the SBFD and non-SBFD symbols, and/or a separate closed loop UL power control for PUSCH reception in the SBFD and non-SBFD symbols.

In a seventh aspect of the present disclosure, a user equipment comprises a memory, a transceiver, and a processor coupled to the memory and the transceiver. The processor is configured to perform the above method.

In an eight aspect of the present disclosure, a base station comprises a memory, a transceiver, and a processor coupled to the memory and the transceiver. The processor is configured to perform the above method.

In a ninth aspect of the present disclosure, a non-transitory machine-readable storage medium has stored thereon instructions that, when executed by a computer, cause the computer to perform the above method.

In a tenth aspect of the present disclosure, a chip includes a processor, configured to call and run a computer program stored in a memory, to cause a device in which the chip is installed to execute the above method.

In an eleventh aspect of the present disclosure, a computer readable storage medium, in which a computer program is stored, causes a computer to execute the above method.

In a twelfth aspect or the present disclosure, a computer program product includes a computer program, and the computer program causes a computer to execute the above method.

In a thirteenth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of frequency resource wasting in DUD subband pattern due to the allocation of RBG to the guard band.

FIG. 2 is a schematic diagram illustrating an example of frequency resource wasting in DU subband pattern due to the allocation of RBG to the guard band.

FIG. 3 is a schematic diagram illustrating an example of mismatch between the boundaries of subband and the boundaries of RBG in DUD subband pattern.

FIG. 4 is a schematic diagram illustrating an example of mismatch between the boundaries of subband and the boundaries of RBG in DU subband pattern.

FIG. 5 is a schematic diagram illustrating an example of non-Contiguous RBs fin PDSCH in DL subbands in DUD subbands pattern.

FIG. 6 is a schematic diagram illustrating an example of SBFD and non SBFD operation in contiguous symbols from gNB perspective.

FIG. 7 is a schematic diagram illustrating an example of scheduling UEs in contiguous SBFD and non SBFD symbols from UE perspective.

FIG. 8 is a block diagram of one or more user equipment's and a network/gNB of communication in a communication network system according to an embodiment of the present disclosure.

FIG. 9A is a flowchart illustrating a method of enhanced frequency resource allocation for sub-band full duplex (SBFD) operation performed by a UE according to an embodiment of the present disclosure.

FIG. 9B is a flowchart illustrating a method of enhanced frequency resource allocation for sub-hand full duplex (SBFD) operation performed by a base station according to an embodiment of the present disclosure.

FIG. 10A is a flowchart illustrating a method of a method of separate parameters indication m SBFD and non-SBFD symbols performed by a UE according to an embodiment of the present disclosure.

FIG. 10B is a flowchart illustrating a method of separate parameters indication in SBFD and non-SBFD symbols performed by a base station according to an embodiment of the present disclosure.

FIG. 11 is a schematic diagram illustrating an example of different Size of RBG for DL/UL subbands and Guard bands according to an embodiment of the present disclosure.

FIG. 12 is a schematic diagram illustrating an example of indication of unaligned RBG with DL subbands boundaries as DL RBG according to an embodiment of the present disclosure.

FIG. 13 is a schematic diagram illustrating an example of indication of unaligned RBG with UL subbands boundaries as UL RBG according to an embodiment of the present disclosure.

FIG. 14 is a schematic diagram illustrating an example of two RIVs in scheduling DCI to indicate non-contiguous RBs of DL subbands for PDSCH to the UE according to an embodiment of the present disclosure.

FIG. 15 is a schematic diagram illustrating an example of two RIVs solution of RBs indication in DUD subband pattern according to an embodiment of the present disclosure.

FIG. 16 is a schematic diagram illustrating an example of RIV indicates all RBs and a new bit de-activate the RBs assigned to PUSCH in UL subband and guard bands according to an embodiment of the present disclosure.

FIG. 17 is a schematic diagram illustrating an example of UEs scheduling in contiguous SBFD and non SBFD symbols in a slot according to an embodiment of the present disclosure.

FIG. 18 is a schematic diagram illustrating an example of PDSCH scheduling of a UE in contiguous DL non SBFD and SBFD symbols according to an embodiment of the present disclosure.

FIG. 19 is a schematic diagram illustrating an example of PUSCH scheduling of a UE in contiguous UL non SBFD and SBFD symbols according to an embodiment of the present disclosure.

FIG. 20 is a schematic diagram illustrating an example of Slot contains SBFD symbols only or non SBFD symbols only according to an embodiment of the present disclosure.

FIG. 21 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The SBFD operation uses the existing physical control channels e.g., PDCCH for DL signalling/scheduling and PUCCH for UL signalling/scheduling, and the existing physical shared channels e.g., PDSCH for DL and PUSCH for UL to perform simultaneous DL and UL transmission In addition, the SBFD operation may use the existing physical resource allocation methods for DL and UL transmission. However, the methods of the existing physical resources allocation are designed for legacy operation according to the bandwidth of the active bandwidth part (BWP) In addition, the existing physical resources allocation are based on contiguous resource allocation in both time domain and frequency domain to perform either DL transmission/reception or UL transmission/reception at a single time period (i.e., time symbols or time slots).

On the other hand. SBFD operation performs simultaneous DL transmission/reception and UL transmission/reception in a time symbols/slots and divide the bandwidth of the active BWP into DL subband (frequency resources assigned to DL) and UL subband (frequency resources assigned to UL). Due to which the existing methods of physical resources allocation for SBFD operation may face several issues and the physical resource allocation requires further enhancement to make it suitable for simultaneous DL and UL transmission/reception (e.g., SBFD operation).

The physical resource allocation to a VE to perform PDSCH reception in DL subband and PUSCH transmission in UL subband such as the frequency resource allocation to the SBFD operation faces the following issues.

### Potential Problem 1: Frequency Domain Resource Allocation

### Frequency Domain Resource Allocation Type 0

In current specification, frequency domain resource allocation (FDRA) type 0 [TS 38.214] is indicated to the UE based on scheduling DCI for PDSCH/PUSCH transmission/reception, where a bitmap indicates the Resource block groups (RBG) assigned to PDSCH/PUSCH. However, using the FDRA type 0 to indicate the frequency resources for PDSCH in DL subband or PUSCH in UL subband may encounter a mismatch between the boundaries of RBG and the boundaries of subband. For instance, in case of [Downlink, Uplink, Downlink] DUD, [Downlink, Uplink] DU or [Uplink, Downlink] UD subbands pattern a mismatch between the boundaries of RBG and the DL and UL sub bands may happen due the following two reasons.

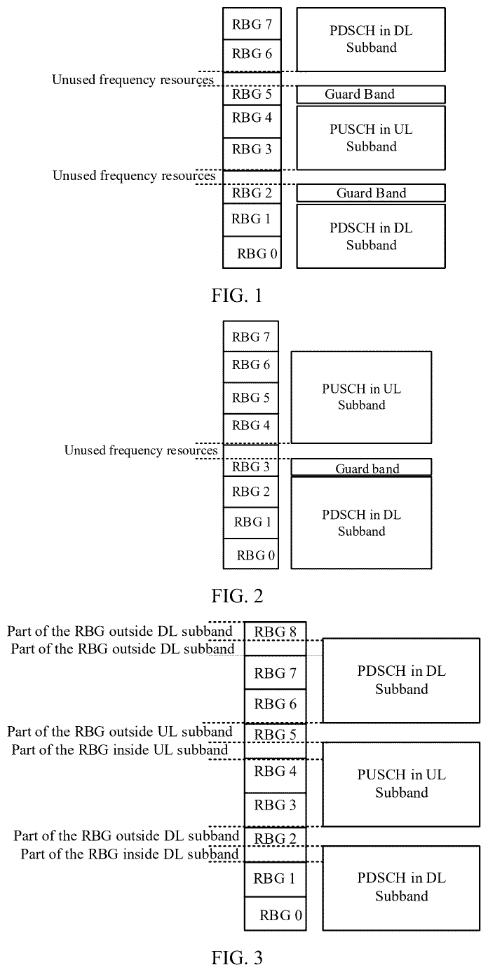

When the guard band is induced between the DL and UL subbands, the RBG assigned to guard band may not be used fir UL or DL subbands, due to which part of the RBG which is assigned to the guard band is wasted. In other words, the frequency resource assignment to the guard band in terms of RBG may contains more RBs than the required RBs for the guard band, which leads to the wasting of frequency resources as shown in FIG. 1 for DUD subband pattern and FIG. 2 for DU subband pattern.

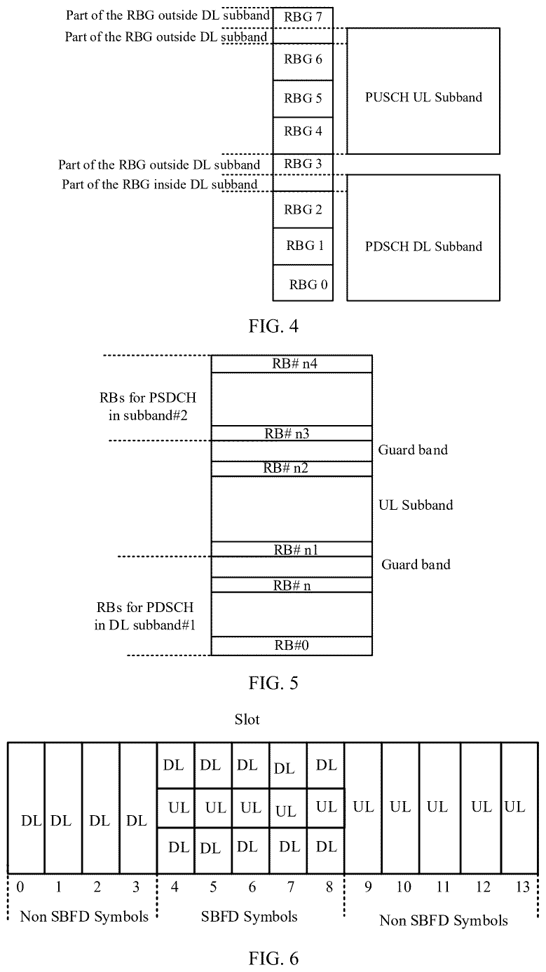

In some cases, due to the bandwidth requirements of DL and UL subbands, the boundaries of the DL and UL subbands may not match with the boundaries of the RBGs, which creates part of the RBG inside the DL or UL subbands and part of the RBG outside the DL or UL subbands as shown in FIG. 3 for DUD subband pattern and FIG. 4 for DU subband pattern. This mismatch leads to the frequency resources wasting according to the current rules of resources allocation type 0.

### Frequency Domain Resource Allocation Type 1

Frequency domain resource allocation type 1 of the current specification uses (Resource indicator value) RIV to indicate frequency resources assigned to the UEs for PDSCH reception or PUSCH transmission, where the RIV contains the start of RBs and the number of RBs (i.e., the length of RBs). Since, the RIV of current specification can indicates the assigned frequency resources in terms of contiguous RBs Thus, the existing resource allocation type 1 may cause incorrect RIV value fix PDSCH across two DL sub-bands in DUD subband patterns as shown in FIG. 5.

### Potential Problem 2: Scheduling a UE in Both SBFD and Non SBFD Symbols/Slots

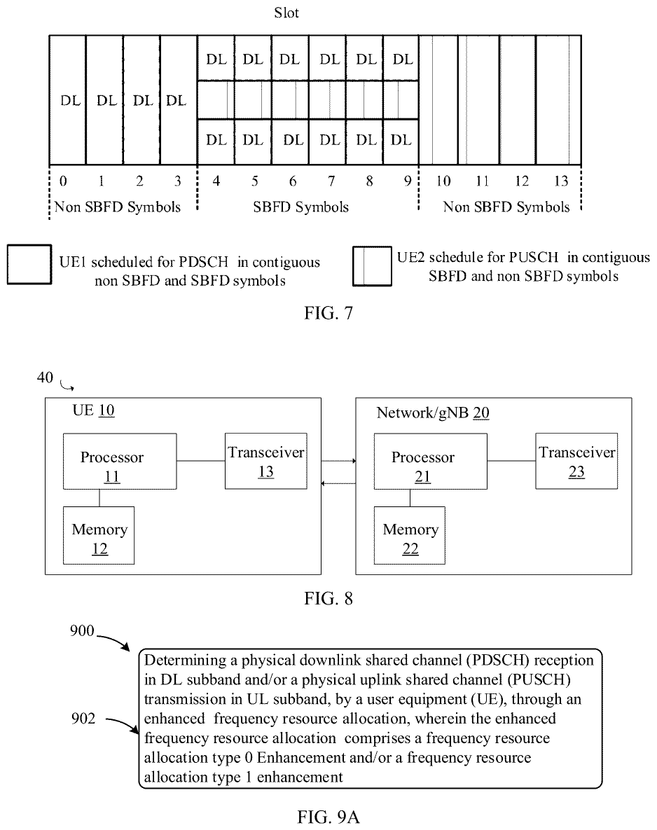

In several scenarios. SBFD operation and non SBFD operation may happens in the contiguous time symbols/slots in other words, a SBFD aware UE may perform both SBFD operation and non SBFD operation in contiguous time symbols/slots. For instance, UE1 and UE2 performs PDSCH reception and PUSCH transmission in both SBFD symbols and non SBFD symbols as shown in FIG. 6. In this case, the PDSCH can be schedule for UE1 in order of non SBFD symbols to the SBFD symbols, and the PUSCH can be schedule for UE2 in the order of SBFD symbols to the non SBFD symbols as shown in FIG. 7.

In such cases, assigning the same scheduling parameters such as the frequency resources, the UL frequency hopping, and the UL power control parameters to a UE for PDSCH reception or PUSCH transmission in SBFD symbols and non SBFD symbols may miss lead a UE to perform the detection of scheduled PDSCH or PUSCH in the physical resources.

FIG. 8 illustrates that, in some embodiments, one or more user equipments (UEs) 10 and a network/gNB 20 for communication in a communication network system 40 according to an embodiment of the present disclosure are provided. The communication network system 40 includes one or more UEs 10 and a network/gNB 20. The one or more UEs 10 may include a memory 12, a transceiver 13, and a processor 11 coupled to the memory 12 and the transceiver 13. The network/gNB 20 may include a memory 22, a transceiver 23, and a processor 21 coupled to the memory 22 and the transceiver 23. The processor 11 or 21 may be configured to implement proposed functions, procedures and/or methods described in this description Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

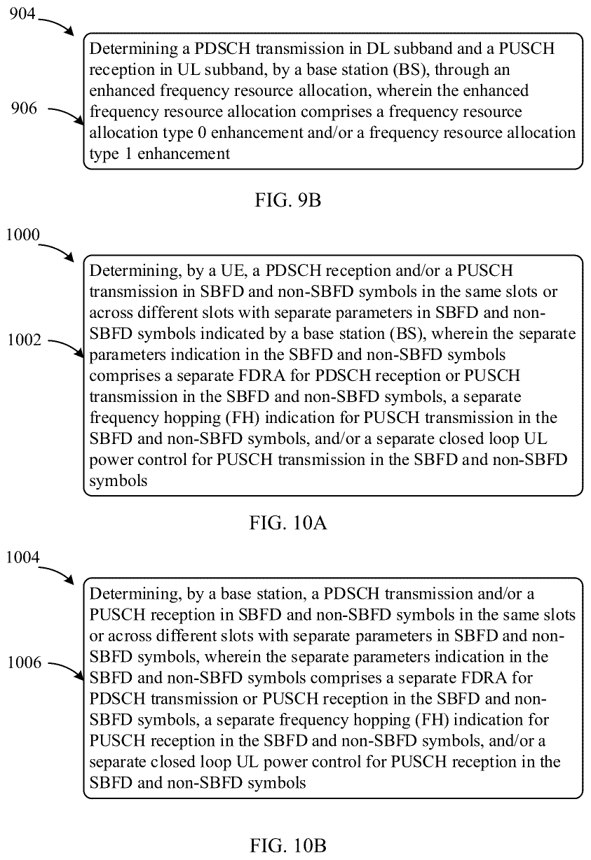

FIG. 9A illustrates a method 900 of enhanced resource allocation for sub-band full duplex (SBFD) operation performed by a UE according to an embodiment of the present disclosure. The method 900 includes a block 902, determining, by a user equipment (UE), a physical downlink shared channel (PDSCH) reception in a downlink (DL) subband and/or a physical uplink shared channel (PUSCH) transmission in an uplink (UL) subband based on an enhanced frequency resource allocation for SBFD operation, wherein the enhanced frequency resource allocation for SBFD operation comprises a frequency resource allocation type 0 enhancement and a frequency resource allocation type 1 enhancement. Further, the processor 11 is configured to perform the above method 900. The processor 11 is also configured to perform the method in the following some embodiments. This can utilize the frequency resources more efficiently.

FIG. 9B illustrates a method 904 of enhanced resource allocation for sub-band full duplex (SBFD) operation performed by a base station according to an embodiment of the present disclosure. The method 904 includes a block 906, determining a PDSCH transmission in DL subband and a PUSCH reception in UL subband, by a base station (BS), based on an enhanced frequency resource allocation, wherein the enhanced frequency resource allocation comprises a frequency resource allocation type 0 enhancement and/or a frequency resource allocation type 1 enhancement. Further, the processor 21 is configured to perform the above method 904. The processor 21 is also configured to perform the method in the following some embodiments. This can utilize the frequency resources more efficiently.

In some embodiments, a method of enhanced frequency resource allocation for sub-band full duplex (SBFD) operation includes determining, by a node, a physical downlink shared channel (PDSCH) transmission/reception in a downlink (DL) subband and/or a physical uplink shared channel (PUSCH) transmission/reception in an uplink (UL) subband based on an enhanced frequency resource allocation for SBFD operation, wherein the enhanced frequency resource allocation for SBFD operation comprises a frequency resource allocation type 0 enhancement and a frequency resource allocation type 1 enhancement. This can increase the SBFD operation flexibility and/or avoid the incorrect configuration of SBFD operation. The node may be a UE or a base station.

In some embodiments, in the frequency resource allocation type 0 enhancement, a size of a resource block group (RBG) for a guard band is different from a size of RBGs configured for DL subbands and/or UL subbands. In some embodiments, the size of the RBG for the guard band is in a range of {2, 4} resource blocks (RBs) per RBG. In some embodiments, in the enhanced frequency resource allocation type 0, a part of a DL RBG inside the DL subband is used for PDSCH transmission/reception, a part of the DL RBG outside the DL subband is used as the guard band, a part of an UL RBG inside the UL subband is used for PUSCH transmission/reception, and/or a part of the UL RGB outside the UL subband is used as the guard band. In some embodiments, in the frequency resource allocation type 0 enhancement, a RBG whose boundary is unaligned with, or extending beyond from a boundary of the DL subband is indicated as the DL RBG and/or a RBG whose boundary is unaligned with, or extending beyond from a boundary of the UL subband is indicated as the UL RBG In some embodiments, in the frequency resource allocation type 0 enhancement, information of the DL subband and/or the UL subband comprises a pattern of the DL subband and/or the UL subband, a frequency location of the DL subband and/or the UL subband, and/or a size of the DL subband and/or the UL subband. In some embodiments, the information of the DL subband and/or the UL subband is determined by the UE based on a semi-static cell common signaling. In some embodiments, a frequency location and/or a size of the guard band is determined by the ULE based on the semi-static cell common signaling or derived by the UE. This can utilize the frequency resources more efficiently.

In some embodiments, in the frequency resource allocation type 1 enhancement, two resource indicator values (RIVs) are used to indicate non-contiguous RBs of DL subbands for PDSCH transmission/reception in downlink, uplink, downlink (DUD) subband pattern In some embodiments, a first RIV of the two RIVs indicates a frequency domain resource allocation (FDRA) for PDSCH transmission/reception in a first DL subband, and a second RIV of the two RIVs indicates the FDRA for PDSCH transmission/reception in a second DL subband in a downlink, uplink, downlink (DUD) subband pattern. In some embodiments, each RIV indicates a starting of RBs and a length of RBs of each DL subband for PDSCH transmission/reception. In some embodiments, in the frequency resource allocation type 1 enhancement, two RIVs are used for PDSCH transmission/reception in a DUD pattern. In some embodiments, a first RIV of the two RIVs indicates all the RBs assigned to DUD subbands or all the RBs in an active bandwidth part (BWP), and a second RIV of the two RIVs indicates the RBs assigned to the UL subband and/or the guard band. In some embodiments, the DUD pattern is determined by the UE based on the semi-static cell common signalling or derived based on the two RIVs by the UE In some embodiments, in the frequency resource allocation type 1 enhancement, one RIV is used to all RBs assigned to a DUD subband pattern, and a bit in the RIV is used to de-activate the RBs assigned to the UL subband and/or the guard band. In some embodiments, the DUD subband pattern and/or a starting and the length of the RBS of each subband are determined by the UE based on a semi static cell common signalling; and/or the RBs assigned to the guard band are determined by the UE based on the semi static cell common signalling or derived by the UE. This can utilize the frequency resources more efficiently.

FIG. 10A illustrates a method 1000 of separate parameters indication in SBFD and non-SBFD symbols performed by a UE according to an embodiment of the present disclosure. The method 1000 includes a block 1002, determining, by a (UE, a PDSCH reception and/or a PUSCH transmission in SBFD and non-SBFD symbols in the same slots or across different slots based on with separate parameters in the SBFD and non-SBFD symbols indicated by a base station (BS), wherein separate parameters indication in the SBFD and non-SBFD symbols comprises a separate FDRA for PDSCH reception or PUSCH transmission in the SBFD and non-SBFD symbols, a separate frequency hopping (FH) indication for PUSCH transmission in the SBFD and non-SBFD symbols, and/or a separate closed loop UL power control for PUSCH transmission in the SBFD and non-SBFD symbols. Further, the processor 11 is configured to perform the above method 1000. The processor 11 is also configured to perform the method in the following some embodiments. This can increase the SBFD operation flexibility and/or avoid the incorrect configuration of SBFD operation.

FIG. 10B illustrates a method 1004 of separate parameters indication in SBFD and non-SBFD symbols performed by a base station according to an embodiment of the present disclosure. The method 1004 includes a block 1006, determining, by a base station, a PDSCH transmission and/or a PUSCH reception in SBFD and non-SBFD symbols in the same slots or across different slots with separate parameters in the SBFD and non-SBFD symbols indicated by a base station (BS), wherein separate parameters indication in the SBFD and non-SBFD symbols comprises a separate FDRA for PDSCH transmission or PUSCH reception in the SBFD and non-SBFD symbols, a separate frequency hopping (FH) indication for PUSCH reception in the SBFD and non-SBFD symbols, and/or a separate closed loop UL power control for PUSCH reception in the SBFD and non-SBFD symbols. Further, the processor 21 is configured to perform the above method 1004. The processor 21 is also configured to perform the method in the following some embodiments. This can increase the SBFD operation flexibility and/or avoid the incorrect configuration of SBFD operation.

In some embodiments, a method of separate parameters indication in SBFD and non-SBFD symbols, comprising, determining, by a node, a PDSCH transmission/reception and/or a PUSCH transmission/reception in SBFD and non-SBFD symbols in the same slots or across different slots with separate based on parameters in the SBFD and non-SBFD symbols indicated by a base station (BS), wherein the separate parameters indication in the SBFD and non-SBFD symbols comprises a separate FDRA for PDSCH transmission/reception or PUSCH transmission/reception in the SBFD and non-SBFD symbols, a separate frequency hopping (FH) indication for PUSCH transmission/reception in the SBFD and non-SBFD symbols, and/or a separate closed loop UL power control for PUSCH transmission/reception in the SBFD and non-SBFD symbols. This can increase the SBFD operation flexibility and/or avoid the incorrect configuration of SBFD operation. The node may be a UE or a base station.

In some embodiments, in the separate FDRA for PDSCH reception or PUSCH transmission in the SBFD and non-SBFD symbols, one DCI indicates frequency resources for PDSCH reception or PUSCH transmission in the SBFD and non-SBFD symbols In some embodiments, anew FDRA field in the one DCI indicates frequency resources for PDSCH reception or PUSCH transmission in the SBFD symbols, and an existing FDRA field of the one DCI indicates the frequency resources for PDSCH reception or PUSCH transmission in the non-SBFD symbols. In some embodiments, a FDRA field of the one DCI indicates frequency resources for PDSCH reception or PUSCH transmission in SBFD and non-SBFD symbols. In some embodiments, in the separate FDRA for PDSCH reception or PUSCH transmission in the SBFD and non-SBFD symbols, a first DCI indicates frequency resources for PDSCH reception or PUSCH transmission in SBFD symbols, and a second DCI indicates the frequency resources for PDSCH reception or PUSCH transmission in non-SBFD symbols. In some embodiments, the first DCIs indicates the separate FDRA assigned to the PDSCH reception in the non-SBFD slot, and the second DCI indicates the separate FDRA assigned to the PDSCH reception in the SBFD slot, where the non-SBFD slot and the SBFD slot are contiguous. In some embodiments, the first DCis indicates the separate FDRA assigned to the PUSCH transmission in the non-SBFD slot, and the second DCI indicates the separate FDRA assigned to the PUSCH transmission in the SBFD slot, where the non-SBFD slot and the SBFD slot are contiguous. This can increase the SBFD operation flexibility and/or avoid the incorrect configuration of SBFD operation.

In some embodiments, in the separate FH indication for PUSCH transmission in the SBFD and non-SBFD symbols, one DCI indicates a FH for PUSCH transmission in the SBFD symbols and non-SBFD symbols In some embodiments, a first field in the one DCI indicates the FH for PUSCH transmission in the SBFD symbols, and a second field of the one DCI indicates the FH for PUSCH transmission in the non-SBFD symbols. In some embodiments, one field in the one DCI indicates the FH for PUSCH transmission in the SBFD symbols and non-SBFD symbols. In some embodiments, in the FH indication for PUSCH transmission in the SBFD and non-SBFD symbols, a UE specific radio resource control (RRC) message indicates a FH for PUSCH transmission in the SBFD symbols. This can increase the SBFD operation flexibility and/or avoid the incorrect configuration of SBFD operation. The separate FH indication may refer to separate frequency resource assignment for UL PUSCH in SBFD and non-SBFD symbols in the same slots or across different slots in the following embodiments, the separate frequency resource assignment will be introduced in detail.

In some embodiments, in the separate closed loop UL power control for PUSCH transmission in the SBFD and non-SBFD symbols, one DCI indicates the separate closed loop UL power control for PUSCH transmission in the SBFD symbols and non-SBFD symbols. In some embodiments, a field in the one DCI indicates the separate closed loop UL power control for PUSCH transmission in the SBFD symbols, and a transmit power control (TPC) field of the one DCI indicates the separate closed loop UL power control for PUSCH transmission in the non-SBFD symbols. In some embodiments, a TPC field in the one DCI indicates the separate closed loop UL power control for PUSCH transmission the SBFD symbols and non-SBFD symbols. In some embodiments, in the separate closed loop UL power control for PUSCH transmission in the SBFD and non-SBFD symbols, a UE specific radio resource control (RRC) message indicates the separate closed loop UL power control for PUSCH transmission in the SBFD symbols. This can increase the SBFD operation flexibility and/or avoid the incorrect configuration of SBFD operation.

### Frequency Domain Resource Allocation/Assignment

This embodiment of the present disclosure proposes several enhancements to the frequency resource allocation to make it suitable for SBFD operation as explained below.

### Frequency Resource Allocation Type 0 Enhancement

In this embodiment of the present disclosure, we propose to enhance the existing rules of type 0 Frequency Domain Resource Allocation (FDRA) for PDSCH transmission/reception in DL sub-bands and PUSCH transmission/reception in UL sub-bands. In current specification the resources type 0 is indicated in DCI based on a bitmap which inform the UE about the (Resource block group) RBG assigned to the PDSCH or PUSCH. However, in SBFD operation for DUD or DU/UD subbands pattern a few RBGs may be assigned to the guard bands, or the boundary of the DL/UL subbands may not match with the boundaries of RBG which increases the resource wasting as explained above. Therefore, this embodiment of the present disclosure proposes the following enhancement to resource allocation type 0.

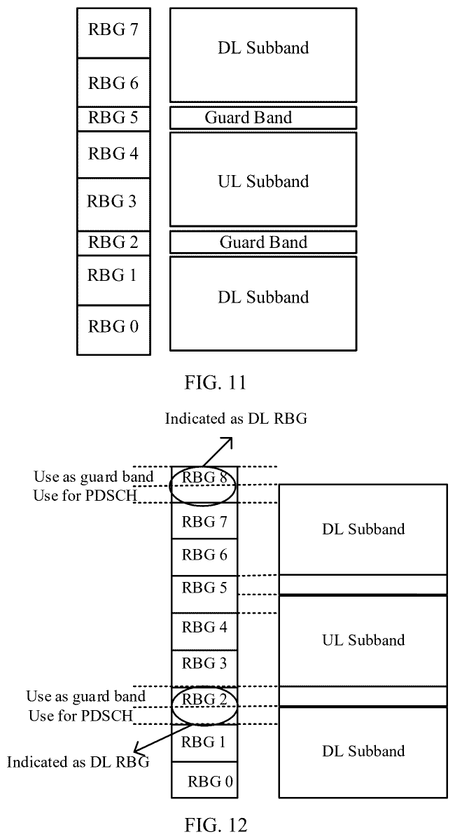

Option 1: Option 1 proposes to configure different size of RBGs assigned to the guard band. According to the current specification, different size of RBGs (i.e., the number of RBs in RBG) can be defined by higher layer parameter rbg-Size and configured by PDSCH-Config, where the size of RBG is adjusted according to the size of the active BWP as shown in table 1 [TS 38.214]. In the same way, this embodiment of the present disclosure proposes to configure the size of RBGs (i.e., the number of RBs in RBG) for guard band according to the required RBs for the guard bands, thus the size of RBG for guard band is different from the size of RBGs configured for the DL and UL subbands as shown in FIG. 11. Furthermore, the size of RBG for guard band can be in the range of {2, 4} RBs per RBG. To achieve this, this embodiment of the present disclosure introduces an extension of new configuration (e.g., configuration 3) for the RBG size of guard band to the existing table of RBG sizes as shown in the third column of table 2. In this way, the size of RBG assigned to the guard band consume less number of RRs, and thus reduces the wasting of frequency resources. Option 1 is to resolve the mismatch between the DL and UL subbands and RBG boundaries, which is created due to the induction of guard bands between the DL and UL subbands.

TABLE 1
Nominal RBG size P of the current specification

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

TABLE 2
Nominal RBG size for SBFD operation

| Bandwidth Part Size | Configuration 1 | Configuration 2 | Configuration 3 |
|---|---|---|---|
| 1-36 | 2 | 4 | 2 |
| 37-72 | 4 | 8 | 2 |
| 73-144 | 8 | 16 | [2, 4] |
| 145-275 | 16 | 16 | [2, 4] |

Option 2: This option proposes predefined rules for type 0 frequency resource allocation and their implementation method, which can solve the mismatch issues occur between the boundaries of DL/UL subbands and RBG, and reduce resource wasting. In this embodiment, the following enhancement rules are proposed. 1. Part of the DL RBG inside the DL subband can be used for PDSCH transmission/reception. 2. Part of the DL. RBG outside the DL subband can be used as a guard band. 3 Part of the UL RBG inside the UL subband can be used for PUSCH transmission/reception. This case assumed that the frequency locations of the DL and UL subbands are known to the SBFD aware which performs UL transmission. 4. Part of the UL RBG outside the UL subband can be used as a guard band. This case assumed that the DL and UL subbands are know the SBFD aware UE which performs UL transmission.

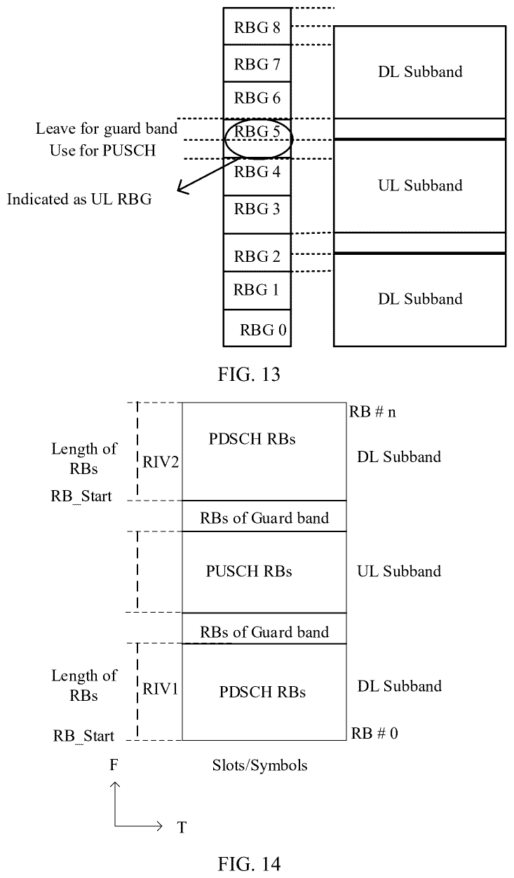

In order to implement the above-predefined rules, the following method can be used for frequency resource allocation type 0.
1. In case of frequency resource allocation type 0 for PDSCH in DL subbands, the RBGs which boundaries are not aligned with boundaries of the DL subband, can be indicated as DL RBG for PDSCH transmission/reception to the UE and apply the above mentioned predefined rules. For instance, the gNB can indicate the RBG2 and RBG8 as DL RBG for PDSCH transmission/reception based on the scheduling DCI to the UE as shown in FIG. 12. Furthermore, the gNB can use part of the RBG2 and RBG8 inside the DL subband for PDSCH transmission and part of the RBG2 and RBG8 outside the DL subband can be leave empty for the guard band as illustrated in FIG. 12.
2. In case of frequency resource allocation type 0, for PUSCH in UL subband, the RBGs which boundaries are not aligned with boundaries of the UL subband, can be indicated as the UL RBG for PSUCH transmission/reception to the UE based on scheduling DCI. The UE can use part of the RBG, which is inside the UL subband for PUSCH transmission, and part of the RBG, which is outside the UL subband, can be left empty for guard band. For instance, when the boundary of RBG5 and UL subband are not aligned, the gNB can indicate the RBG5 as UL RBG for PUSCH transmission/reception in the scheduling DCI as shown in FIG. 13. Furthermore, the UE can use part of the RBG5 inside the UL subband for PUSCH transmission and part of the RBG5 outside the DL subband can be left empty for guard band as illustrated in FIG. 13.

For option 2, it is assumed that the following information are known to the UE based on semi-static cell common signalling (e.g., TDD-UL-DL ConfigCommon) 1. The pattern of subband (e.g., DUD, DU or ID). 2 The frequency location of the DL and UL subband or size of the DL and UL subbands in terms of bandwidth. 3. The frequency location or the size of the guard band is explicitly indicated based on cell common semi-static configuration or implicitly derived by the UE.

### Frequency Resource Allocation Type 1 Enhancement

Frequency Resource allocation type 1 of the current specification uses (Resource indicator value) RIV to indicate the frequency resources assigned for PDSCH or PUSCH to the UEs in the scheduling DCIs, where the RIV contains the starting of the RBs and the length of RBs (total number of RBs from the starting RB). In addition, the frequency resource assignment indicated by RIV is contiguous RBs which cannot be used to indicate the frequency resource for PDSCH in two DL sub-bands in DUD subbands pattern as explained above.

Therefore, this embodiment of the present disclosure proposes the following enhancement for type 1 FDRA type 1 to indicated the frequency resources the DL subband in the scheduling DCI for PDSCH.

### Two RIV Based Solution in Scheduling DCI

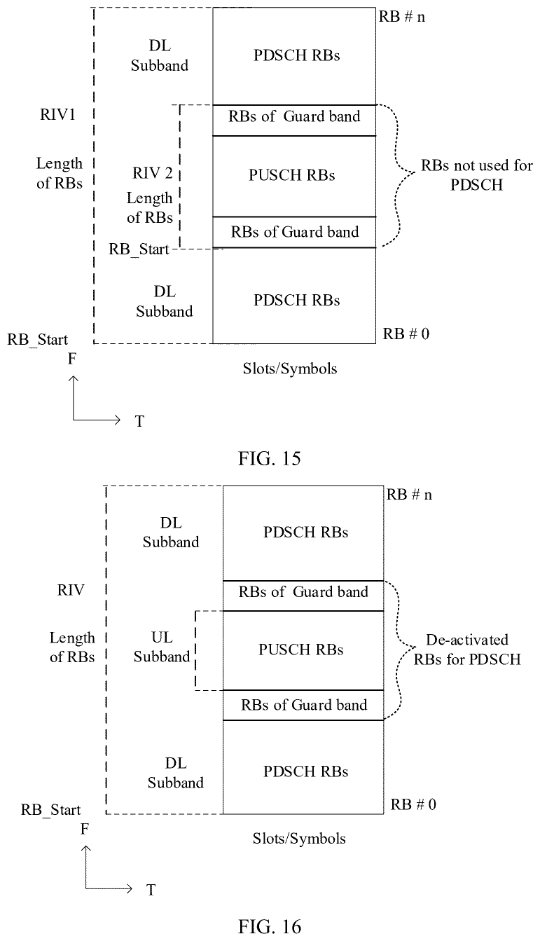

1. On simple solutions is to use two RIV in scheduling DCI for PDSCH, where the first RIV indicates the FDRA assigned to PDSCH transmission/reception in DL sub-band 1 and second RIV indicates FDRA for PDSCH transmission/reception in DL sub-band 2 in DUD subband pattern. In addition, each RIV indicates the starting of RBs and length of RBs of each DL sub-band for PDSCH as shown in FIG. 14. In this way, the resource allocation type 1 can be used for scheduling PDSCH in DUD subbands pattern as illustrated in FIG. 14.
2. Another solution is to use two RIV in scheduling DCI for PDSCH in DUD pattern, where the first RIV indicates all the RBs assigned to the DUD subbands (or all the RBs in the active BWP) and the second RIV indicates the RBs assigned to the UL sub-band and the guard bands. From the second RIV the UE can derive that the RBs assigned to the UL subband and guard bands cannot be used for PDSCH transmission/reception as shown in FIG. 15. In this case, even if the pattern of DUD is not indicated based on the semi-static cell common signalling, the UE can derive the subband pattern from the both RIV values implicitly.

### One RIV Based Solution in Scheduling DCI

This embodiment of present disclosure proposes to introduce a new bit in the legacy RIV, where the RIV indicates all the RBs assigned to the DUD subband pattern and the new bit is used to de-activate the RBs assigned to the UL sub-bands and/or the guard band as shown in FIG. 16. However, for this solution, the subband pattern e.g. DUD, the starting and number of RBs of each subband is known to the SBFD aware UE based on the semi static cell common signalling. In addition, it is also assumed that the RBs assigned to the guard band is implicitly derived by the SBFD aware UEs or explicitly indicated based on semi static cell common signalling.

### Resources Allocation and Parameters Indication for SBFD and Non-SBFD Symbols

### Frequency Domain Resource Allocation for SBFD and Non SBFD Symbols

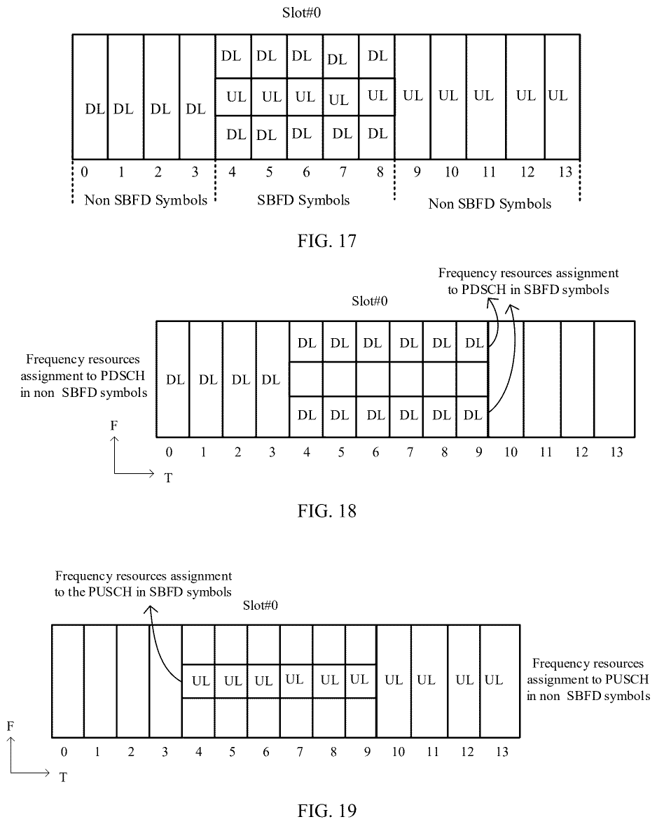

In this embodiment of the present disclosure, we discuss separate frequency resource assignment for SBFD and non-SBFD symbols in the same slots or across different slots. In several scenarios, the order of (Frequency domain resource assignment) FDRA in SBFD symbols/slots is different from the order of the FDRA in non-SBFD symbols/slots, due to different bandwidth in SBFD symbols and non SBFD symbols. For instance, let consider slot #0 which contains both SBFD symbols and non SBFD symbols as shown in FIG. 17, where the frequency resources (in terms of RBs or RBGs) are assigned to UE1 and UE2 for PDSCH transmission/reception and PUSCH transmission/reception respectively. The order of frequency resources assigned to the UE1 for PDSCH reception is different in non SBFD symbols SBFD from the SBFD symbols as shown in FIG. 18. Similarly, the order of frequency resources assigned to UE2 for PUSCH transmission in SBFD symbols is different from the non SBFD symbols as shown in FIG. 19. Therefore, assigning the same order of frequency resources (e g. RBs start and total number of RBs) to a UE which performs PDSCH reception or PUSCH transmission in SBFD symbols and non SBFD symbols is not correct.

In order to solve this issue, this embodiment of the present disclosure propose to assign separate FDRA to the UEs for PDSCH reception or PUSCH transmission in SBFD symbols/slots and non SBFD symbols/slots. The method of Frequency resources assignment for SBD and non SBFD symbols can be performed by the following two methods.

Method 1: Using legacy scheduling DCI to indicate the separate frequency resources assignment to the UE for PDSCH/PUSCH transmission/reception in both SBFD symbols and non SBFD symbols. In this case the following two options can be used.
1. A new field is introduced in the legacy DC which indicates the frequency resource assignment for PDSCH or PUSCH to a IE in SBFD symbols, and the existing field of FDRA indicates the frequency resources for PDSCH or PUSCH in non SBFD symbols.
2. The existing FDRA field of the scheduling DCI is extended to include the indication of Frequency resources for PDSCH or PUSCH in SBFD symbols. In this way, one field indicates the frequency resources assigned to PDSCH or PUSCH in SBFD and non SBFD symbols.

Method 2. Two scheduling DCI based FDRA indication to one UE.

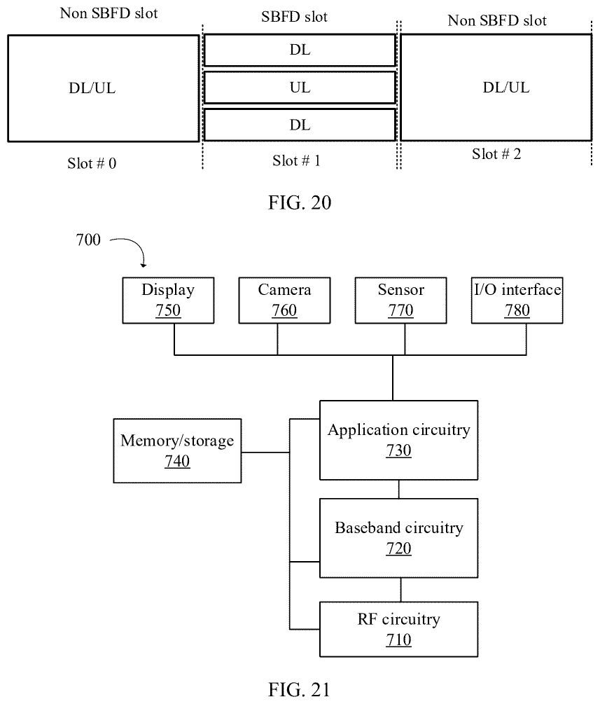

In this method two scheduling DCIs are used to indicate the FDRA of PDSCH or PUSCH transmission/reception in SBFD and non SBFD slot to a UE, where the first DCI indicates the FDRA of PDSCH or PUSCH in SBFD slot and the second DC indicates the FDRA assigned to PDSCH or PUSCH in non SBFD slot. This method is suitable only when a slot contains SBFD symbols only or non SBFD symbols only as shown in FIG. 20.
1. For FDRA assigned to the UE for PDSCH in non SBFD slots can be indicated based on the first scheduling DCI, and the FDRA assigned to the same UE for PDSCH in DL subbands can be indicated based on the second scheduling DCI. Thus, two DCI indicates separate FDRA assigned to PDSCH in contiguous non SBFD and SBFD slots.
2. For FDRA assigned to PUSCH in contiguous SBFD slot and non SBFD slot, a first cross slot scheduling DCIs indicates separate FDRA assigned to PUSCH of UL subband in SBFD slot, and a second same slot scheduling DCI indicates the FDRA resources assigned to PUSCH in UL slot.

### Separate FH Range for SBFD Operation and Non SBFD Operation

The separate FH indication may refer to separate frequency resource assignment for UL PUSCH in SBFD and non-SBFD symbols in the same slots or across different slots. In the following embodiments, the separate frequency resource assignment will be introduced in detail.

In this embodiment of the present disclosure, we discuss separate frequency resource assignment for UL PUSCH in SBFD and non-SBFD symbols in the same slots or across different slots.

The range of the frequency hopping (i.e. the RBₛₜₐᵣₜ and RB_{offset} of frequency hopping) in legacy symbols/slots (non-SBFD symbols/slots) is different from the SBFD symbols. For instance, the starting RB in each hop for non SBFD symbols in intra-slot frequency hopping, is given in below [TS 38.314].

$${RB}_{\text{?}} = \{ \begin{matrix}{RB}_{\text{?}} & i = 0 \\ ( {RB}_{\text{?}} + {RB}_{\text{?}} ) mod {N}_{\text{?}}^{\text{?}} & i = 1\end{matrix} ,$$

$$\text{?} \text{indicates text missing or illegible when filed}$$

where i=0 and i=1 are the first hop and the second hop respectively, and RBₛₜₐᵣₜ is the starting RB within the UL BWP, as calculated from the resource block assignment information of resource allocation type1, and RB_{offset} is the frequency offset in RBs between the two frequency hops. Moreover, when the UL BWP is less than 50 RBs, two RBs offsets are configured by higher layer and 1 bit in DCI indicates one of the two offsets. Similarly, when the UL BWP is larger than 50 RBs, four RBs offsets are configured by higher layer and two bits in the DCI indicate one of the four offsets as given in table 3.

TABLE 3
Frequency offset for second hop of PUSCH transmission
[TS 38.314 Table 8.3-1]

| Number of PRBs in | Value of N_{UL,hop} | Frequency offset |
|---|---|---|
| initial UL BWP | Hopping Bits | for 2^{nd} hop |
| ${N}_{BWP}^{size} < 50$ | 0 | $⌊ {N}_{BWP}^{size} / 2 ⌋$ |
| | 1 | $⌊ {N}_{BWP}^{size} / 4 ⌋$ |
| ${N}_{BWP}^{size} \geq 50$ | 00 | $⌊ {N}_{BWP}^{size} / 2 ⌋$ |
| | 01 | $⌊ {N}_{BWP}^{size} / 4 ⌋$ |
| | 10 | $- ⌊ {N}_{BWP}^{size} / 4 ⌋$ |
| | 11 | Reserved |

Since the starting RB start and the RB offset of the legacy symbols/slots is designed according to the bandwidth of BWP which may lead the PUSCH frequency resource hops outside the bandwidth of the UL subband.

In order to solve this issue, this embodiment of the present disclosure proposes a new range of the UL frequency hopping for PUSCH in SBFD symbols (e.g., the starting RB and the RB offset) according to the bandwidth of the UL subband. For instance, the RB start and the RB_offset of intra slot frequency hopping in SBFD symbols is given below.

$${RB}_{start}^{UL subband} = \{ \begin{matrix}{RB}_{start}^{UL subband} & i = 0 \\ ( {RB}_{start}^{UL subband} + {RB}_{offset}^{UL subband} ) mod {N}_{UL subband}^{size} & i = 1\end{matrix} ,$$

where the

$${RB}_{start}^{UL subband}$$

is the starting RB within the UL subband and

$${RB}_{offset}^{UL subband}$$

is the new frequency offset in RBs between the two frequency hops within the size of the UL subband. The

$${RB}_{offset}^{UL subband}$$

for the second frequency hop SBFD symbols can be defined according to the size of the UL subband as given in table 4.

TABLE 4
Frequency offset for second hop of PUSCH transmission of UL subband

| Number of PRBs in UL subband | Frequency offset for 2nd hop |
|---|---|
| ${N}_{UL subabnd}^{size}$ | $⌊ {N}_{UL Subabnd}^{size} / 2 ⌋$ |
| | $⌊ {N}_{UL subband}^{size} / 4 ⌋$ |

In addition, in case a UE performs PUSCH transmission in both SBFD symbols and non SBFD symbols in a same slot or across the different slots as explained in above scenarios, then a separate FH shall be indicated for both SBFD symbols and non SBFD symbols. The method of FH indication for PUSCH in SBFD and non SBFD symbols can be performed by the following two methods.

Method 1: Using one legacy DCI to indicate the FH assignment for PUSCH in both SBFD symbols and non SBFD symbols. In this case the following two options can be used.

Option 1: A new field is introduced in the legacy scheduling DCI to indicate the FH for PUSCH to a UE in SBFD symbols. In this way the existing field of the FH indication indicates the FH for PUSCH in non SBFD symbols.

Option 2: The existing FH field of the legacy scheduling DCI is extended to include the indication of FH for PUSCH SBFD symbols. In this way, one field indicates the FT lor PUSCH in SBFD and non SBFD symbols. However, option 2 may affect the non SBFD operation of the legacy UEs.

Method 2: The UL specific RRC message can be used to indicate the FH parameters of SBFD symbols to the UE separately from the FH parameter of the non SBFD symbol. This RRC message can be configured in the PUSCH-Config to indicate the frequency hopping of SBFD symbols. The example configuration is shown below.

### The Example Configuration

| | |
|---|---|
| PUSCH-Config ::= | SEQUENCE |

```
  {
    (...)
  frequencyHopping-UL subband ENUMERATED {intraSlot, interSlot} OPTIONAL, -- Need S
```

| | |
|---|---|
| requencyHoppingOffsetLists-UL subband | SEQUENCE (SIZE (1..2)) OF INTEGER (1.. |

maxNrofPhysicalResourceBlocks−1)
(...)
}
}
FrequencyHopping-UL-Subband: Indicate the frequency hopping within the range of UL subband
FrequencyHoppingOffsetLists-UL-subabnd: Indicate the set of frequency hopping offset define for
the UL subband according to the bandwidth of UL subbands

### Separate UL Power Control Parameters

The uplink transmissions in the UL subband may generate UE-to-UE CLI with different interference levels due to different frequency domain isolation between the uplink transmission and the DL subband. To solve the issue of UE to UE CLI the closed-loop power control parameter (e.g., TPC table) configured for SBFD symbols may be different from the non SBFD symbol in order to reduce the effect of CLI. However, the TPC of SBFD symbols can be different from the non SBFD symbols. Therefore, this embodiment of the present disclosure proposes to indicate a separate closed loop power control parameter for PUSCH in SBFD symbols/slots which is different from the PSUCH in non SBFD symbols.

The method of separate closed loop UL power control (e.g., TPC) for PUSCH in SBFD and non SBFD symbols can use the legacy scheduling DCL.

Method 1 Using the legacy scheduling DCI to indicate separate TPC for PUSCH in both SBFD symbols and non SBFD symbols. In this case the following two options can be used.

Option 1: A new field is introduced in the legacy scheduling DCI to indicate the TPC for PUSCH to a UE in SBFD symbols, and the existing field of TPC indication indicates the TPC for PUSCH in non SBFD symbols.

Option 2: The existing TPC field of the existing DCI is extended to include the indication of TPC for PUSCH SBFD symbols. In this way, one field indicates the TPC for PUSCH in SBFD and non SBFD symbols. However, option 2 may affect the non SBFD operation of the legacy UEs.

Method 2: The UE specific RRC message can be used to indicate the closed loop UL TPC parameters of SBFD symbols to the UE. For this purpose, the RRC message can be configured in the PUSCH-Config to indicate the closed loop TPC of SBFD symbols, which separate the closed loop Lt. TPC of the SBFD symbols from the non SBFD symbol.

In summary, this disclosure discusses and proposes several solutions to enhance the physical resource allocation of the current specification in order to reduce the physical resource wasting and efficiently utilize the physical resources for SBFD operation. The proposed solutions to achieve our objectives are summarized as below. 1. Several enhancements of FDRA type 0 and type 1 are proposed to minimize the frequency resource wasting and utilize the frequency resources more efficiently as given below. For FDRA type 0: A new configuration for RBG with less number of RBs for guard band is proposed to avoid the mismatch between the boundaries of DL/UL subband with the boundaries of RBG. Predefined rules and its indication methods are proposed in order to utilize the frequency resources inside the DL, or UL subband for PDSCH or PUSCH transmission/reception. For FDRA type 1 Two Resource indication value (RIV) based solutions are proposed to indicate the non-contiguous resource allocation for PDSCH to the UE in DUD subband pattern. One RIV based solutions with a new bit is proposed to indicate the non-contiguous resource allocation for PDSCH to the UE in DUD subband pattern 2. Separate physical resource parameters such as (separate FDRA, separate UL frequency hopping, separate UL power control) for SBFD operation and non SBFD operation in contiguous time symbols/slots are proposed to avoid the incorrect scheduling of PDSCH in DL subband and PUSCH in UL subbands. This disclosure discusses the physical resource allocation enhancement and have the following advantages. 1. The proposed methods and solutions consider the physical resource enhancement in frequency domain and utilize the frequency resources more efficiently. 2. The proposed methods and solutions consider the SBFD and non-SBFD operation in a slot, which increases the SBFD operation flexibility. 3 The proposed methods and solutions consider several parameters enhancement, which avoids the incorrect configuration of SBFD operation.

FIG. 21 is a block diagram of an example system 700 for wireless communication according to an embodiment of the present disclosure. Embodiments described herein may be implemented into the system using any suitably configured hardware and/or software. FIG. 21 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of enhanced frequency resource allocation for sub-band full duplex (SBFD) operation, comprising:
determining, by a node, a physical downlink shared channel (PDSCH) transmission/reception in a downlink (DL) subband and/or a physical uplink shared channel (PUSCH) transmission/reception in an uplink (UL) subband based on an enhanced frequency resource allocation for SBFD operation, wherein the enhanced frequency resource allocation for SBFD operation comprises a frequency resource allocation type 0 enhancement and/or a frequency resource allocation type 1 enhancement; and information of the DL subbands and/or the UL subband is determined based on a semi-static cell common signaling.

2. The method of enhanced frequency resource allocation for SBFD operation of claim 1, wherein the node is a user equipment (UE), and the UE is configured to determine the PDSCH reception in the DL subband and/or the PUSCH transmission in the UL subband based on the enhanced frequency resource allocation for SBFD operation.

3. The method of enhanced frequency resource allocation for SBFD operation of claim 1, wherein the node is a base station, and the base station is configured to determine the PDSCH transmission in the DL subband and/or the PUSCH reception in the UL subband based on the enhanced frequency resource allocation for SBFD operation.

4-9. (canceled)

10. The method of enhanced frequency resource allocation for SBFD operation according to claim 1, wherein a frequency location and/or a size of a guard band is determined by the UE based on the semi-static cell common signalling or derived by the UE.

11. The method of enhanced frequency resource allocation for SBFD operation according to claim 1, wherein in the frequency resource allocation type 1 enhancement, two resource indicator values (RIVs) are used to indicate non-contiguous RBs of DL subbands for PDSCH transmission/reception in downlink, uplink, downlink (DUD) subband pattern.

12. The method of enhanced frequency resource allocation for SBFD operation according to claim 11, wherein a first RIV of the two RIVs indicates a frequency domain resource allocation (FDRA) for PDSCH transmission/reception in a first DL subband, and a second RIV of the two RIVs indicates the FDRA for PDSCH transmission/reception in a second DL subband in a downlink, uplink, downlink (DUD) subband pattern.

13. The method of enhanced frequency resource allocation for SBFD operation according to claim 11, wherein each RIV indicates a starting of RBs and a length of RBs of each DL subband for PDSCH transmission/reception.

14. The method of enhanced frequency resource allocation for SBFD operation according to claim 1, wherein in the frequency resource allocation type 1 enhancement, two RIVs are used for PDSCH transmission/reception in a DUD pattern.

15. The method of enhanced frequency resource allocation for SBFD operation according to claim 14, wherein a first RIV of the two RIVs indicates all the RBs assigned to DUD subbands or all the RBs in an active bandwidth part (BWP), and a second RIV of the two RIVs indicates the RBs assigned to the UL subband and/or the guard band.

16. The method of enhanced frequency resource allocation for SBFD operation according to claim 14, wherein the DUD pattern is determined by the UE based on the semi-static cell common signalling or derived based on the two RIVs by the UE.

17. The method of enhanced frequency resource allocation enhancement for SBFD operation according to claim 1, wherein in the frequency resource allocation type 1 enhancement, one RIV is used to all RBs assigned to a DUD subband pattern, and a bit in the RIV is used to de-activate the RBs assigned to the UL subband and/or the guard band.

18. The method of enhanced frequency resource allocation for SBFD operation according to claim 17, wherein the DUD subband pattern and/or a starting and the length of the RBS of each subband are determined by the UE based on a semi static cell common signalling; and/or the RBs assigned to the guard band are determined by the UE based on the semi static cell common signalling or derived by the UE.

19. A method of separate parameters indication in SBFD and non-SBFD symbols, comprising:
determining, by a node, a PDSCH transmission/reception and/or a PUSCH transmission/reception in SBFD and non-SBFD symbols in the same slots or across different slots with separate parameters in the SBFD and non-SBFD symbols indicated by a base station (BS), wherein the separate parameters indication in the SBFD and non-SBFD symbols comprises a separate FDRA for PDSCH transmission/reception or PUSCH transmission/reception in the SBFD and non-SBFD symbols, a separate frequency hopping (FH) indication for PUSCH transmission/reception in the SBFD and non-SBFD symbols, and/or a separate closed loop UL power control for PUSCH transmission/reception in the SBFD and non-SBFD symbols, and wherein the node is a user equipment (UE) or the base station.

20-25. (canceled)

26. The method of separate parameters indication in SBFD and non-SBFD symbols according to claim 19, wherein in the separate FH indication for PUSCH transmission/reception in the SBFD and non-SBFD symbols, one DCI indicates a FH for PUSCH transmission/reception in the SBFD symbols and non-SBFD symbols.

27-28. (canceled)

29. The method of separate parameters indication in SBFD and non-SBFD symbols according to claim 19, wherein in the FH indication for PUSCH transmission/reception in the SBFD and non-SBFD symbols, a UE specific radio resource control (RRC) message indicates a FH offset for PUSCH transmission/reception in the SBFD symbols.

30. The method of separate parameters indication in SBFD and non-SBFD symbols according to claim 19, wherein in the separate closed loop UL power control for PUSCH transmission/reception in the SBFD and non-SBFD symbols, one DCI indicates the separate closed loop UL power control for PUSCH transmission/reception in the SBFD symbols and non-SBFD symbols.

31. The method of separate parameters indication in SBFD and non-SBFD symbols according to claim 29, wherein a field in the one DCI indicates the separate closed loop UL power control for PUSCH transmission/reception in the SBFD symbols, and a transmit power control (TPC) field of the one DCI indicates the separate closed loop UL power control for PUSCH transmission/reception in the non-SBFD symbols.

32. (canceled)

33. The method of separate parameters indication in SBFD and non-SBFD symbols according to claim 19, wherein in the separate closed loop UL power control for PUSCH transmission/reception in the SBFD and non-SBFD symbols, a UE specific radio resource control (RRC) message indicates the separate closed loop UL power control for PUSCH transmission/reception in the SBFD symbols.

34-36. (canceled)

37. The method of separate parameters indication in SBFD and non-SBFD symbols according to claim 19, wherein a frequency offset of a second frequency hop is determined based on a size of the UL subband.

38. The method of separate parameters indication in SBFD and non-SBFD symbols according to claim 19, wherein the UE specific RRC message further indicates a frequency hopping offset lists for PUSCH transmission/reception in SBFD symbols.
